(19) United States
(12) Patent Application Publication
(10) Pub. No.: US 2004/0260593 A1
(43) Pub. Date: Dec. 23, 2004

(54) System and user interface supporting workflow operation improvement

(76) Inventors: Klaus Abraham-Fuchs, Erlangen (DE); Horst Siebold, Effeltrich (DE); Gerhard Weller, Erlangen (DE)

Correspondence Address: Alexander J. Burke, Intellectual Property Department 5th Floor, 170 Wood Avenue South, Iselin, NJ, 08830, US

(21) Appl. No.: 10/849,407

(22) Filed: May 19, 2004

Related U.S. Application Data
(60) Provisional application No. 60/471,946, filed on May 20, 2003.

(51) Int. Cl. G06F 17/60

(52) U.S. Cl. 705/8

(57) ABSTRACT

A system for use in improving management of a workflow process includes an interface processor, a data processor, and an analyzer. The workflow process includes a sequence of tasks to be performed by one or more individuals. The interface processor receives a message indicating an occurrence of a performance deficiency in a workflow process. The data processor stores records in a repository in response to the received message. The records include data representing current workflow context information and information identifying the performance deficiency. The analyzer analyzes the data in the record identifying the performance deficiency to support improvement of the workflow process.

### CROSS-REFERENCE TO RELATED APPLICATIONS

The present application is a non-provisional application of provisional application having Ser. No. 60/471,946 filed by Klaus Abraham-Fuchs, et al. on May 20, 2003.

### FIELD OF THE INVENTION

The present invention generally relates to information systems. More particularly, the present invention relates to a system and user interface supporting workflow operation improvement.

### BACKGROUND OF THE INVENTION

Industrial enterprises currently employ intra-company, improvement suggestion systems. A purpose of suggestion systems is to stimulate participants in the operational processes to identify process deficiencies and put forward optimization proposals on their own initiative and from their observations of the day-to-day working situation. Suggestion systems permit the industrial enterprises to realize considerable cost savings or quality improvements.

The use of software-based workflow support and control systems (“workflow management systems”) has increased steadily over the last several years. Workflow management systems are designed to manage complex processes that include individual work steps in a workflow performed by multiple workers and systems. A workflow is a sequence and schedule of tasks to be performed by one or more individuals and/or systems. Workflow management systems are increasingly used in the non-industrial domain, for example, healthcare enterprises, such as clinics and hospitals. To optimally employ a workflow management system in a healthcare enterprise, it is desirable that a system supports configuration of a workflow at a local level. The local level may be within a facility or department where the workflow is to be implemented, for example. Examples of the local level in a healthcare enterprise include, for example, nursing, laboratory, pharmacy, and radiology departments. For this purpose, clinical processes are mapped into machine-readable workflow models and the entire workflow is supported, monitored, and documented by a computer network. Toward that end, workflows are broken down into discrete “action steps,” responsibilities assigned and necessary resources allocated, and essential data forwarded and provided by automated means (e.g. using a workflow engine). At decision nodes in a workflow process, electronic decision support (such as provided by a rules engine) may use knowledge-based expert systems, for example.

Workflow operational processes are optimized during an initial implementation phase of a workflow management system and may be standardized across an enterprise. However such implementation may have been unrealistic, the software interface may not be optimal, or the processes may be changing due to advances in knowledge.

Although, it is known in the software field to maintain a problem record (a problem log) and to prompt a user with a performance questionnaire (particularly in Internet based services), such systems are inadequate to address the problems involved in maintaining and improving often complex and multi-computer based workflow systems in the healthcare and other fields. Known software problem log systems (such as the Microsoft® Dr. Watson program) typically run in the background of an executing application and record the context of a program error and (optionally) forward the resulting log to a software vendor. Accordingly, there is a need for a system and user interface supporting workflow operation improvement that overcomes these and other disadvantages of the prior systems.

### SUMMARY OF THE INVENTION

Although, prior systems may capture user and task context during a workflow task sequence, the prior systems do not record and document improvement information (user or automated feedback) derived by observation of an end user. Further, although a performance questionnaire may allow a user to assess performance or enter text regarding a particular condition, the known systems fail to provide systematic feedback and analysis encompassing a workflow process sequence in a workflow management system.

According to one aspect of the present invention, a system for use in improving management of a workflow process includes an interface processor, a data processor, and an analyzer. The workflow process includes a sequence of tasks to be performed by one or more individuals. The interface processor receives a message indicating an occurrence of a performance deficiency in a workflow process. The data processor stores records in a repository in response to the received message. The records include data representing current workflow context information and information identifying the performance deficiency. The analyzer analyzes the data in the record identifying the performance deficiency to support improvement of the workflow process.

### BRIEF DESCRIPTION OF THE DRAWINGS

FIG. 1 illustrates block diagram of an information system, in accordance with a preferred embodiment of the present invention.

FIG. 2 illustrates a block diagram of a workflow management system, as shown in FIG. 1, in accordance with a preferred embodiment of the present invention.

FIG. 3 illustrates a flowchart showing a workflow management method performed by the workflow management system, as shown in FIG. 2, in accordance with a preferred embodiment of the present invention.

### DETAILED DESCRIPTION OF THE PREFERRED EMBODIMENTS

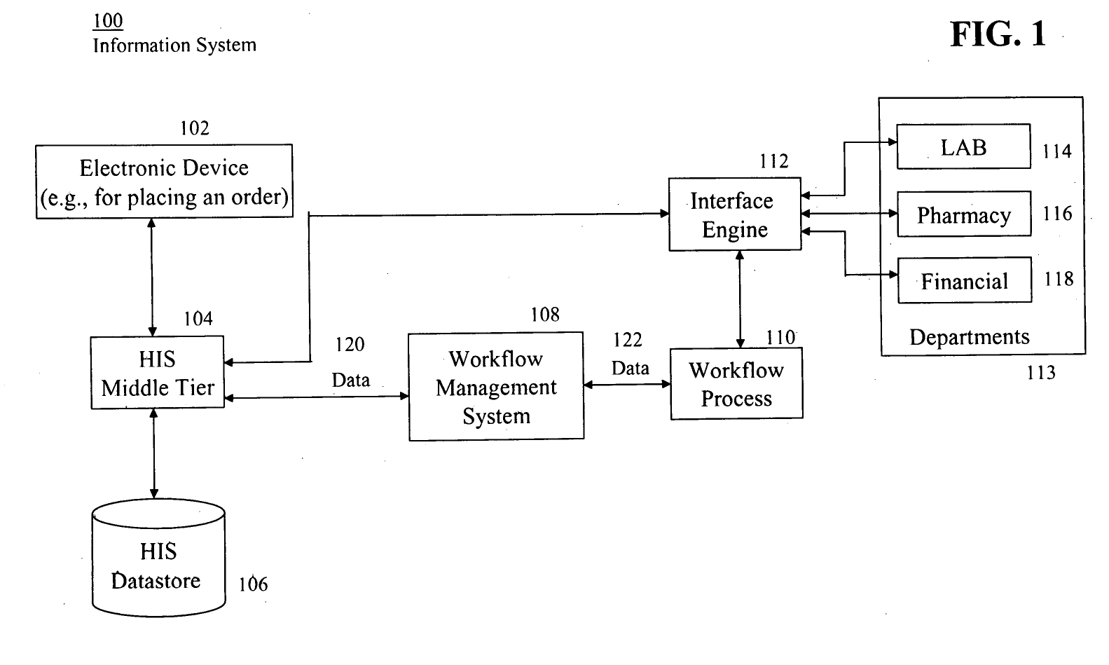

FIG. 1 illustrates block diagram of an information system 100, in accordance with a preferred embodiment of the present invention. The information system 100 generally includes an electronic device 102, a hospital information system (HIS) 104, a HIS data store 106, a workflow management system 108, a workflow process 110, an interface engine 112, and departments 113. The departments 113 include, for example and without limitation, a lab 114, a pharmacy 116, and a financial group 118. The workflow management system 108 receives data 120 and generates data 122.

The information system 100 is intended for use by a healthcare provider that is responsible for servicing the health and/or welfare of people in its care. A healthcare provider may provide services directed to the mental, emotional, or physical well being of a patient. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. When servicing a person in its care, a healthcare provider diagnoses a condition or disease, and recommends a course of treatment to cure the condition, if such treatment exists, or provides preventative healthcare services. Examples of the people being serviced by a healthcare provider include, without limitation, a patient, a resident, a client, a user, and an individual.

The electronic device 102 provides an electronic mechanism for a healthcare provider (otherwise called a “healthcare worker”) to access the provider system 100. The electronic device 102 may be fixed or mobile (i.e., portable), and may be implemented in a variety of forms including, without limitation, a desktop computer, a laptop computer, a workstation, a network-based device, a personal digital assistant (PDA), a smart card, a cellular telephone, a pager, and a wristwatch. The electronic device 102 may be implemented in a centralized or decentralized configuration.

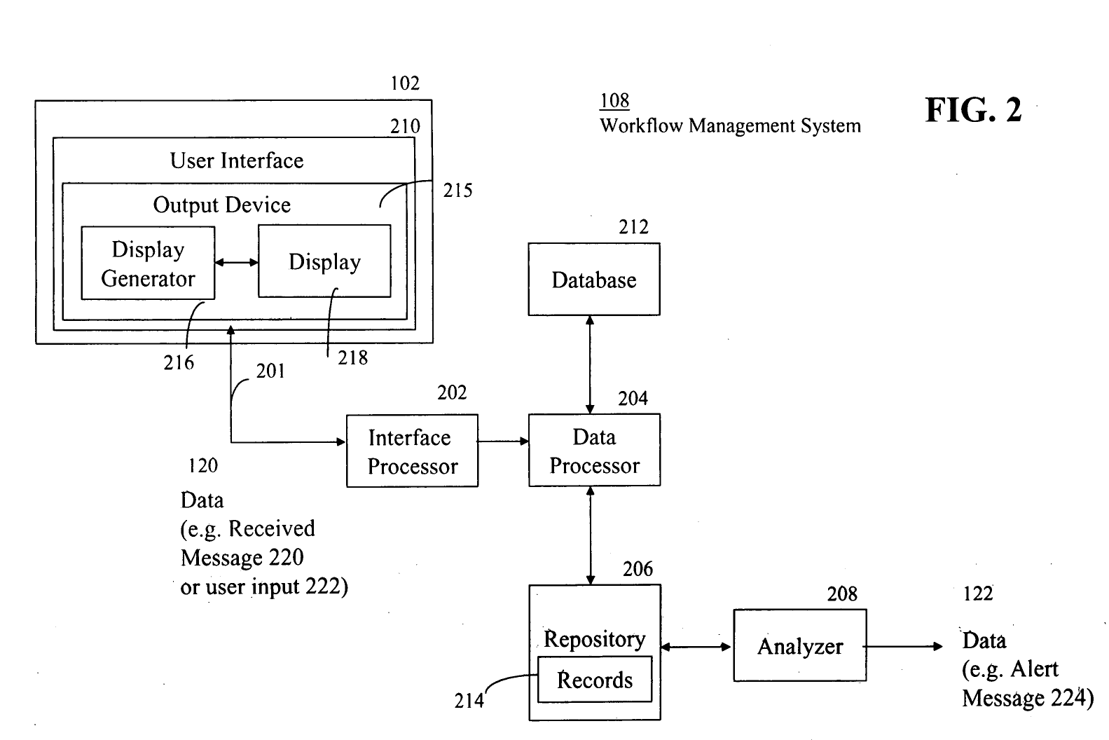

The electronic device 102 includes a user interface 210, shown in FIG. 2, having an input device (not shown) that permits a user to input information into the electronic device 102 and an output device 215 that permits a user to receive information from the electronic device 102. Preferably, the input device is a keyboard, but also may be a touch screen, or a microphone with a voice recognition program, for example. Preferably, the output device 215 is a display generator 216 and a display 218, but also may be a speaker, for example. The output device 215 provides information to the user in response to the input device receiving information from a user or in response to other activity by the electronic device 102. For example, a display 218 presents information in response to a user entering information in the electronic device 102 via a keyboard.

The user interface provides a graphical user interface (GUI), wherein at least portions of the input device and at least portions of the output device are integrated together to provide a user-friendly device. For example, a web browser forms a part of each of the input device and the output device by permitting information to be entered into the web browser and by permitting information to be displayed by the web browser. Many different GUI techniques for inputting data and outputting data, using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts.

The electronic device 102 communicates with the interface processor 202 in the workflow management system 108 over a communication path 201. The term “path” may otherwise be called a network, a link, a channel, or a connection.

The communication path 201 may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, a Digital and Imaging Communications (DICOM) protocol, and an Health Level Seven (HL7) protocol.

The communication path 201 may use any type of address scheme including, without limitation, an address corresponding to a type of protocol described above, and a Universal Resource Locator (URL), otherwise called a web page address. The communication path 201 may communicate any type of data for any type of application including, without limitation, still pictures, streaming video, audio, telephone messages, computer programs, messages, instructions, and Emails.

The communication path 201 may be formed as a wired and/or wireless (W/WL) connection. A wireless connection advantageously permits the electronic device 102 to be mobile beyond the distance permitted by the wired connection. Preferably, the communication path 201 is formed as a wired connection. The wired connection may include physical wires formed as a serial or parallel bus. In the case of a wired connection, an IP address may be assigned to a physical location of the termination point of the wire. In the case of a wireless connection, the IP address may be assigned to the electronic device 102, since the electronic device 102 would be mobile.

The communication path 201 may be formed as any type of network including, without limitation, a local area network (LAN), such as an Intranet, for example, and a wide area network (WAN), such as an Internet, for example. Preferably, the communication path 201 is formed as the WAN, such as the Internet. The Internet is a decentralized network of computers that communicate with one another via TCP/IP.

The electronic device 201 may be considered a client and the remaining elements of the information system 100 are considered part of a server to form a client-server system. A web browser, such as Explorer™ (MicroSoft Corp.) or Navigator™ (Netscape Communication Corp.), installed on the client sends a message over the Internet to the server. The message requests a web page identified by a uniform resource locator (URL), which notes both the server where the web page resides and the file or files on that server which make up the web page. The server sends a copy of the requested file(s) to the web browser, which in turn displays the web page to the user. The web pages on the Internet may be hyper-media documents written in a standardized language called Hyper Text Markup Language (HTML). A typical web page includes text together with embedded formatting commands, referred to as tags, which can be used to control font size, font style and the like.

The healthcare information is generated, originated, or sourced by one or more various departments 113, otherwise called healthcare sources within the information system 100. Examples of the healthcare sources include, without limitation, a hospital system, a medical system, and a physician system, a records system, a radiology system, an accounting system, a billing system, and any other system required or desired in the information system 100. The hospital system further includes, without limitation, a lab system, a pharmacy system, a financial system, and a nursing system. The medical system, otherwise called an enterprise, represents a healthcare clinic or another hospital system. The physician system represents a physician's office.

The healthcare information may be represented in a variety of file formats including, without limitation and in any combination, numeric files, text files, graphic files, video files, audio files, and visual files. The graphic files include a graphical trace including, for example, an electrocardiogram (EKG) trace, an electrocardiogram (ECG) trace, and an electroencephalogram (EEG) trace. The video files include a still video image or a video image sequence. The audio files include an audio sound or an audio segment. The visual files include a diagnostic image including, for example, a magnetic resonance image (MRI), an X-ray, a positive emission tomography (PET) scan, or a sonogram.

In the information system 100 of FIG. 1 and/or the workflow management system 108 of FIG. 2, one or more elements, as shown and described herein, may include one or more processors. As used herein, a processor comprises any one or combination of, hardware, firmware, and/or software. A processor acts upon stored and/or received information by manipulating, analyzing, modifying, converting, or transmitting information for use by an executable procedure or an information device, and/or by routing the information to an output device. A processor may use or comprise the capabilities of a controller or microprocessor, for example.

A processor performs tasks in response to processing an object. An object, as used herein, comprises a grouping of data and/or executable instructions, an executable procedure, or an executable application. An executable application, as used herein, comprises code or machine readable instruction for implementing predetermined functions including those of an operating system, healthcare information system or other information processing system, for example, in response user command or input. An executable procedure as used herein is a segment of code (machine readable instruction), sub-routine, or other distinct section of code or portion of an executable application for performing one or more particular processes and may include performing operations on received input parameters (or in response to received input parameters) and provide resulting output parameters. A calling procedure is a procedure for enabling execution of another procedure in response to a received command or instruction.

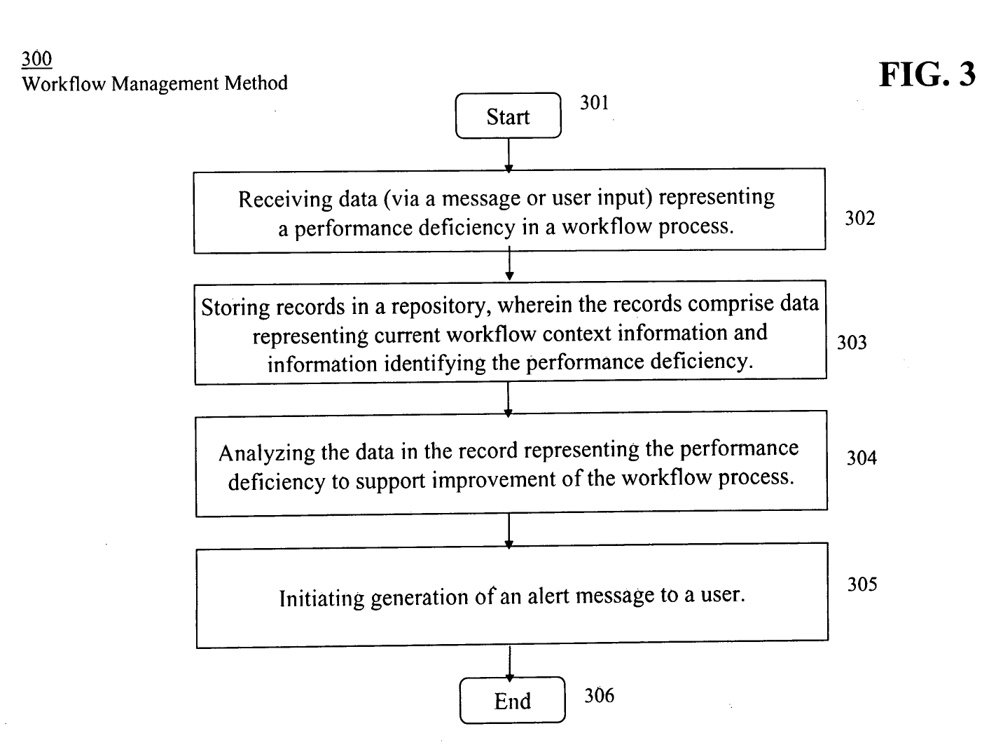

The information system 100, shown in FIG. 1, beneficially provides improves and optimizes workflow processes using workflow participant context sensitive input and records. The information system 100 uses a workflow management method, as shown in FIG. 3, for integrating workflow participant input, records, and suggestions in a workflow management system.

A challenge for the development of innovative condition recording and logging solutions in the workflow field is provided by the relatively high degree of complexity of workflow management system, which necessarily include interfaces to non-software-based processes in an enterprise. Typically, existing systems operate as a pure software solution limited to one computer and its input media. By contrast, the workflow management system 108 controls not just one computer process, but a real workflow in an enterprise involving people and resources participating in the process. The information system 100, shown in FIG. 1, advantageously improves workflow operation in response to process participant suggestions and other process data fed back during operation of a workflow process. The information system 100 supports the customized configuration of workflow processes, as well as continuous monitoring and management of workflow processes during workflow operation.

In operation, the information system 100, shown in FIG. 1, supports creation and configuration of a workflow process (comprising task sequences to be performed) and manages the workflow process. A configured workflow processes is linked to events generated from the hospital information system (HIS) 104. In response to user actions generated at the electronic device 102, the HIS 104, using the data store 106, generates event messages 220, as shown in FIG. 2, and communicates them to the workflow management system (WFMS) 108. The event messages include event identifiers and metadata that identify user actions and other occurrences associated with healthcare delivery and support that take place in a healthcare enterprise and potentially affect healthcare delivered to a patient. The HIS 104 communicates via messages 220 with external systems, such as the departments 113, through the interface engine 112 and with the WFMS 108. The WFMS 108 manages the workflow process and advantageously provides a performance, deficiency management system, as describe in FIG. 3.

FIG. 2 illustrates a block diagram of a workflow management system 200, as shown in FIG. 1, in accordance with a preferred embodiment of the present invention. The workflow management system 200 generally includes an interface processor 202, a data processor 204, a repository 206, an analyzer 208, a user interface 210, and a database 212. The repository further includes records 214. The user interface 210 in the electronic device 102 further includes the display generator 216 and the display 218. The data 120, shown as being received by the workflow management system 108 in FIG. 1, is represented by a received message 220 and/or by a user input 222. The analyzer 208 generates the data 122, represented by an alert message 224, for example, for the workflow process 110, as shown in FIG. 1.

Generally, workflow management system 108 is for use in improving management of the workflow process 110, as shown in FIG. 1. The workflow process 110 includes a sequence of tasks to be performed by one or more individuals to support healthcare delivery to a patient.

The interface processor 202 receives a message 120, which indicates occurrence of a performance deficiency in a workflow process. The data processor 204 stores records 214 in the repository 206. The records 214 include data representing current workflow context information and information identifying the performance deficiency. The analyzer 208 analyzes the data in the records 214 identifying the performance deficiency to support improvement of the workflow process.

The data processor 204 may store multiple records in one or more repositories 206 in response to the received message 220. In this case, the multiple records 214 include data representing current workflow context information and information identifying multiple corresponding performance deficiencies. The data processor 204 stores the plurality of records 214 in chronological sequence to facilitate identification of a time of first occurrence of a particular performance deficiency. The analyzer 208 analyzes the data in the records 214, identifying the multiple corresponding performance deficiencies, to identify a pattern of performance deficiencies in the workflow process. The analyzer 208 prioritizes the identified pattern of performance deficiencies in the workflow process in response to analyzing the records 214. The analyzer 208 initiates generation of an alert message 224 to a user in response to analyzing the records 214. The data processor 204 stores a pointer for use in locating the records 214 in the one or more repositories 206.

The performance deficiency includes one or more of the following: (a) an error, (b) a deficiency in operation, (c) performance below a performance achievable with a proposed workflow process modification, (d) a deficiency of speed of operation, (e) a deficiency in usability, (f) a deficiency in efficiency, (g) a deficiency in operational capability, and (h) a deficiency in output quality.

The context information includes one or more of the following: (a) a time, (b) a user identifier, (c) a workflow task identifier, (d) a workflow process input parameter, (e) a workflow process output parameter, (f) a decision rule applied in the workflow process, (g) a location, (h) an active participant, (i) an input terminal, and (j) a workflow task result.

The received message 220, indicating occurrence of a performance deficiency in a workflow process, is initiated in response to one or more of the following: (a) user data entry in a generated user interface display image 218, and (b) automated performance assessment derived from workflow process operation monitoring.

The analyzer 208 automatically parses the message 222 indicating occurrence of the performance deficiency to identify a category of the performance deficiency. In this case, the analyzer 208 automatically identifies the category of the performance deficiency by one or more of: (a) text string matching, and (b) key word matching. The analyzer 208 initiates generation of an alert message 224 to a particular participant associated with the identified category of performance deficiency based on a stored map associating the particular participant with the category. The analyzer 208 analyzes the data in the records by statistically evaluating error frequency of identified performance deficiencies associated with particular workflow tasks.

The display generator 216 is a known element comprising electronic circuitry and/or software that initiates or generates display of data, representing one or more images or portions thereof, enabling a user to enter data 222 identifying a performance deficiency in a workflow process. In this case, the data processor 204 stores the one or more records 214 in the one or more repositories 206 in response to the entered data 222.

The one or more images displayed by the display 218 supports user entry of items including one or more of the following: (a) data identifying a particular performance deficiency by selection from a predetermined list of items indicating predetermined categories of performance deficiency, (b) text concerning a particular performance deficiency, (c) data selecting a checkbox identifying a particular performance deficiency from a plurality of checkboxes associated with a corresponding plurality of predetermined categories of performance deficiency, (d) data identifying a particular performance deficiency, (e) data identifying a magnitude of a particular performance deficiency, (f) data identifying urgency of a particular performance deficiency, and (g) data identifying user dissatisfaction with particular workflow task performance. The data processor 204 stores the records 214 including data, representing workflow context information, in response to the user entry of the items.

The one or more images displayed by the display 218 includes pre-populated items including one or more of the following: (a) a time, (b) a user identifier, (c) a context identifier, (d) a workflow task identifier, (e) a workflow process input parameter, (f) a workflow process output parameter, (g) a decision rule applied in the workflow process, (h) a location, (i) an active participant and (j) a workflow task result, and (k) a terminal identifier.

The display generator 216 initiates display of data representing a workflow image supporting user performance of a task involved in delivering healthcare to a patient. The workflow image includes an image element enabling user initiation of display of the data representing the one or more images enabling a user to enter data identifying the performance deficiency in the workflow process.

The display generator 216 automatically selects a particular image for display enabling a user to enter data identifying the performance deficiency in the workflow process. The particular image is selected based on a type of workflow task associated with the performance deficiency. The particular image for display is selected from images including one or more of the following: (a) an option list, (b) a bar enabling entry of a value on a scale, (c) a bar enabling entry of a colored element representing a value on a scale, (d) a message initiation option, (e) a hotline initiation option, and (f) an urgency selection option.

The database 212 associates the performance deficiency with a particular type of user interaction. The type of user interaction being associated with one or more of the following: (a) input of data in support of a workflow process, (b) output of data in response to a workflow process, and (c) a decision made in support of a workflow process. The display generator 216 may automatically select an image for display in response to the particular type of user interaction associated with the type of workflow task. In this case, the database 212 may also associate a category of performance deficiency with the type of user interaction.

The database 212 may also associate the performance deficiency with a particular attribute. The attribute includes one or more of the following: (a) presence of data in a workflow process, (b) lateness of arrival of data in response to a workflow process, (c) quality of performance of a task of a workflow process, (d) resources associated with a workflow process, (e) responsibility for a task of a workflow process, (f) urgency associated with a task of a workflow process, and (g) severity of a problem associated with performance of a task of a workflow process. The display generator 216 automatically selects one or more images for display in response to the particular attribute. The one or more images enable a user to interactively modify an image supporting user entry of data identifying a performance deficiency in a workflow process.

More particularly, the performance management system supports context-based, integrated recording of an intellectual effort on the part of the process participant to recognize process deficiencies, identify and quantify the deficiencies, and where appropriate formulate suggestions for improvement. This means that a process participant is able to input improvement information into the system at a precise point (e.g., a particular sub-task within a particular task performed by a particular individual and at a particular time) during a workflow task sequence where other workflow task conditions, inputs, and outputs are also captured. The system is able to identify, record, analyze, and improve workflow process characteristics and operation based on workflow process-improvement information initiated by a user or that is automatically acquired. The improvement information may be advantageously acquired at a point in the workflow task sequence at which a process deficiency or its effect is readily apparent to a process participant. The improvement information is also advantageously acquired at a point in the workflow task sequence at which a process participant is interactively active at a graphical user interface of a workflow management system, so there is minimal additional overhead involved in inputting feedback. Further, the workflow process context at the time a deficiency occurred is automatically recorded and documented for subsequent evaluation. The system 108 also enables a user to enter improvement data concurrently with workflow process operation so a user does not have to exit an application or graphical user interface (GUI) in order to switch from workflow process control operation to enable entry of improvement information. The system 108 thereby advantageously enables a process participant to assess process critically and recognize process deficiencies, and to document and communicate knowledge gained in a way that requires little time and effort.

The system 108 supports context-dependent process information recording in a log file in the event of an error, a particular status, or a process quality deficiency. The system 108 further supports context-based recording of process quality deficiencies and/or improvement suggestions by a process participant by means of input aids in a GUI of a workflow management system.

In response to automatic or process participant generation or entry of improvement information concerning a sequence process deficiency in the workflow task, the system 108 records current workflow context data in a log file and stored for evaluation together with the improvement information. The context data includes information identifying, for example and without limitation: a process, a time of occurrence of the deficiency, a location, a user, last data inputs and outputs, decision rules of a rules engine being applied together with a result of applying the rules, a workflow process operation history, a workflow process interface involved, active participants, input terminal identifier, and user identification information.

The system 108 advantageously stores process context data in chronological sequence from a past time at which a participant is provided an option of entering or generating improvement information via the user interface image to a present time at which the participant is entering or generating the improvement information. If no improvement information was entered about a process deficiency at the past occasion, it may be assumed that the cause of the process deficiency may lie in the logged task sequence information occurring in the workflow process task, sequence steps occurring between the two occasions. This enables a problem or deficiency to be determined by analysis of the log file of the particular workflow operation sequence occurring between the two occasions. By contrast, known software problem logging systems store software status in the event of software error and do not record process status in the event of workflow process deficiency identification (and recording) by automatic means or interactive user input.

The system 108 incorporates features in the user interface 210. Specifically, the user interface 210 advantageously enables interactive process participant input of observations related to process deficiencies. The interface 210 is user-friendly, easy, and efficient to use. The user interface 210 provides an activation option enabling participant data input concerning process deficiencies, via known data entry devices (mouse, buttons, keyboard, etc.). In response to user selection of an activation option, at least one input window opens in a user interface display image, into which a user enters observation information, for example, as plaintext or can check one or more predefined selection options, which characterize a process deficiency. The system 108 stores user inputs and transfers the improvement information or a pointer to the improvement information to a central process administrator or a central server.

The system 108 generates one or more display images and windows including an input window for plaintext, in which time, terminal identification (ID) and/or user ID are optionally already entered. Another input window presents a list identifying possible process deficiencies, with the option to select one or more pertinent formulations. Other input windows show a menu containing graphical elements that characterize possible process deficiencies, with the option to select one or more pertinent graphical elements (e.g. [symbol] )) and a menu containing a scale, in which the magnitude of the process deficiency may be quantified. For example, the process deficiency may be quantified by selecting predefined numbers between −3 and +3, or by clicking on color fields of a color scale from green, through amber, to red. Another displayed menu includes a scale that records the urgency of the need for action or with which the process deficiency may be remedied. The scale is specified by selection from categories “minutes”, “hours”, “days”, or by selection of predefined numbers between −3 and +3, or by clicking on color fields of a color scale from green, through amber, to red. One menu item supports user selection of an icon (e.g., ( [symbol] ) in order to document dissatisfaction with a process.

In a further advantageous embodiment, the system 108 automatically evaluates improvement information. For this purpose, the system 108 automatically directs pre-categorized improvement information (e.g., categorized upon initial user entry or upon automatic generation or subsequently by automated expert system assignment employing a keyword or text comparison method, for example) to personnel (e.g., determined from a database) responsible for this category of improvement or to an automated system for continuously improving workflow operation. The system 108 automatically statistically evaluates an error frequency from multiple user inputs or workflow management system generated inputs, and prioritizes inputs in order of handling urgency. The system 108 also automatically statistically evaluates error frequency from numerous user inputs or workflow management system generated inputs derived from different workflow process interfaces in order to quantify the accumulation of process deficiencies in specific sub-processes and to isolate the potential cause of a deficiency in the process chain.

The system 108 context-based input capability integrated in graphical user interfaces of the workflow management system 108 supports acquisition of improvement information from process participants and facilitates identification of process deficiencies. The system 108 also facilitates user entry of improvement information by employing standardized and therefore easy-to-evaluate improvement information data entry using predetermined electronic and information categorizing forms, for example. Selectable input options enable the magnitude of the process deficiency to be quantified. Statistical analysis of improvement information is facilitated by providing input capability at multiple points in an enterprise that uses a particular process, or by many different participants in the same process. Conclusions about the gravity of a process deficiency are derived from the number of inputs at a particular process interface and a cause of a process deficiency is isolated by accessing information from multiple inputs at different process interfaces.

The system 108 advantageously records context-dependent process information in a log file in the event of an error status or identified process quality deficiency (derived from manual input or automatically generated). The system 108 also advantageously provides user interface features in a workflow management system 108 supporting context-based recording of workflow process improvement information including information identifying quality deficiencies and/or improvement suggestions by a process participant.

A software method supports computer-aided configuration of graphical user interfaces (GUIs) for user improvement information concerning workflow management systems 108. By contrast, prior systems typically do not provide graphical user interfaces for workflow management systems that employ parameters of a process model for workflow improvement a configuration.

For the sake of clarity, the following definitions apply:

Action step=Discrete step in a task sequence.

Workflow=Sequential, parallel or conditional sequence of action steps.

Input data=Output data required in order to perform an action step.

Output data=Data constituting the result of a fully completed action step.

Resources=Equipment (ECG machine, CT scanner, etc.), individuals (medical consultant, nursing staff, etc.) or infrastructure (e.g. intensive care unit) required for performing an action step.

The system 108 provides a generic tool for software-based configuration of graphical user interfaces (GUIs) that are used for recording improvement information from the process participant at an arbitrary process interface so that a suitable GUI does not have to be conceived and developed from scratch for sub-processes. The system 108 automatically configures and implements an input mask for each interactive process interface in the workflow management system, using the standardized process model of this sub-process as described in the database 212 by means of parameters (e.g. input, output, resources, responsibility, decision rule). In a further embodiment, at least one candidate configuration is produced for an input mask that may be modified interactively by means of a GUI during the implementation phase of the workflow management system 108.

For this purpose, an option set of input masks is stored in a database along with details of their suitability for specified input categories. Here, the option set comprises in particular two improvement information variants:

1. Context-based recording and input aid for the intellectual effort of the process participant

2. Automated recording of operator error states, impermissible time delays in the process, deficient quality of input/output data, failure of resources, etc.

Interactive user interfaces in a workflow management system 108 can be described, for example, as three interaction categories: data input, data output, or confirmation/selection of decision proposals at decision nodes.

Accordingly, with a goal of providing a generic tool, three tool variants are also used. Suitable improvement information categories assigned for to corresponding interaction categories may be, for example:

1. Input category: Improvement information concerning the input data (e.g., not available, arrived late, poor quality, doubtful quality, etc.).

2. Output category: Improvement information concerning expected output (e.g., not available, arrived late, poor quality, doubtful quality, etc.).

3. Decision category: Improvement information concerning decision proposal (e.g., not put forward, put forward late, basis for decision not established, anticipated decision variant not put forward, responsibility for decision unclear/not established, etc.).

As a further module in addition to the interaction categories and the improvement information categories, the tool also includes a selection portfolio of graphical input masks (e.g. dropdown lists for checking, selectable icons, etc.) to which the suitability for a specific improvement information category is assigned in each case.

A generic tool advantageously provides an improved user interface 210 employing one or more databases 212, and supports assignment of options. Specifically, the user interface 210 supports selection of options for categorizing three categories of improvement information (e.g., INPUT, OUTPUT, and DECISION categories) and these categories are associated by a database with corresponding input masks (e.g., data entry menus). An example of a database 212 of this type could look as follows:

Database 1a

| Interaction | Assigned improvement |
|---|---|
| category | information categories |
| INPUT | F1, F2, F3, F4 |
| OUTPUT | F1, F2, F3, F4 |
| DECISION | F1, F2, F3, F6, F7, F8 |
| . . . | |

Database 1b

| | Improvement information categories | Assigned input masks |
|---|---|---|
| F1 | Presence | I2 |
| F2 | Lateness | I3, I7 |
| F3 | Quality | I2, I3, I4 |
| F4 | Resources | I5 |
| F5 | Responsibility | |
| F6 | Urgency | I3, I4, I7 |
| F7 | Severity | I2, I3, I4 |
| F8 | | |
| . . . | | |

Database 1c

| | Input masks |
|---|---|
| I1 | Dropdown list |
| I2 | Icon bar Faces |
| I3 | Scoring bar −3 . . . +3 |
| I4 | Scoring bar Color scale |
| I5 | Messaging service |
| I6 | Call hotline |
| I7 | Icon bar Urgency |
| . . . | |

The system 108 supports automated configuration of an input interface for user improvement information concerning process deficiencies and comprises

1. A database 212 with parameters of a process model.

2. One or more databases 1a, 1b, 1c with interaction categories and an option set for categorizing improvement information and having associated corresponding input menus. The databases 1a, 1b, 1c determine permitted combinations of input menu options and associated improvement categories. Further, an expert system produces one or more candidates for an input interface, and selects suitable input menus for a sub-process based on workflow process parameters of the database 212. An input interface menu produced by the expert system is modifiable by a user. The expert system automatically incorporates a selected input interface into an application for a workflow management system 108.

The system 108 advantageously includes databases using process model parameters, templates for GUIs and expert rules permitting efficient configuration and implementation of GUIs supporting user input of standardized, integrated user improvement information for workflow management systems 108 and underlying operational processes.

FIG. 3 illustrates a flowchart showing a workflow management method 300 performed by the workflow management system 200, as shown in FIG. 2, in accordance with a preferred embodiment of the present invention. The method 300 is for use in improving management of the workflow process 110, which includes a sequence of tasks to be performed by one or more individuals to support healthcare delivery to a patient. The method 300 generally includes steps (otherwise called “activities”) 301-306, described as follows.

At step 301, the method starts.

At step 302, the workflow management system 200 receives data 120 (via a message 220, as shown in FIG. 2, or a user input 222, as shown in FIG. 2) representing a performance deficiency in a workflow process. In particular, the workflow management system 200 receives the message 220 indicating an occurrence of a performance deficiency in a workflow process. In particular, the workflow management system 200 initiates display of data representing one or more images enabling a user to enter data 222 identifying a performance deficiency in a workflow process.

At step 303, the workflow management system 200 stores the records 214 in the repository 206 in response to receiving the data 120. The records 214 include data representing current workflow context information and information identifying the performance deficiency.

At step 304, the workflow management system 200 analyzes the data in the records 214 representing (otherwise called “identifying”) the performance deficiency to support improvement of the workflow process in response to storing the records 214.

At step 305, the workflow management system 200 initiates generation of data 122 (e.g. an alert message 224, as shown in FIG. 2) to a user in response to analyzing the data in the records 214.

At step 306, the method ends.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system for use in improving management of a workflow process, said workflow process comprising a sequence of tasks to be performed by at least one individual, comprising:
an interface processor for receiving a message indicating occurrence of a performance deficiency in a workflow process;
a data processor for storing records in a repository, said record comprising data representing current workflow context information and information identifying said performance deficiency, in response to said received message; and
an analyzer for analyzing said data in said record identifying said performance deficiency to support improvement of said workflow process.

2. A system according to claim 1, wherein
said data processor stores a plurality of records in at least one repository, said records comprising data representing current workflow context information and information identifying a plurality of corresponding performance deficiencies, and
said analyzer analyzes said data in said records identifying said performance deficiencies to identify a pattern of performance deficiencies in said workflow process.

3. A system according to claim 2, wherein
said analyzer prioritizes identified performance deficiencies in said workflow process.

4. A system according to claim 2, wherein
said analyzer initiates generation of an alert message to a user in response to analyzing said records.

5. A system according to claim 2, wherein
said data processor stores said plurality of records in chronological sequence to facilitate identification of a time of first occurrence of a particular performance deficiency.

6. A system according to claim 1, wherein
said performance deficiency comprises at least one of, (a) an error, (b) a deficiency in operation, (c) performance below a performance achievable with a proposed workflow process modification, (d) a deficiency of speed of operation, (e) a deficiency in usability, (f) a deficiency in efficiency, (g) a deficiency in operational capability and (h) a deficiency in output quality.

7. A system according to claim 1, wherein
said context information includes at least one of, (a) a time, (b) a user identifier, (c) a workflow task identifier, (d) a workflow process input parameter, (e) a workflow process output parameter, (f) a decision rule applied in said workflow process, (g) a location, (h) an active participant, (i) an input terminal and (j) a workflow task result.

8. A system according to claim 1, wherein
said received message indicating occurrence of a performance deficiency in a workflow process is initiated in response to at least one of, (a) user data entry in a generated user interface display image and (b) automated performance assessment derived from workflow process operation monitoring.

9. A system according to claim 1, wherein
said workflow process comprising a sequence of tasks to be performed by at least one individual to support healthcare delivery to a patient.

10. A system according to claim 1, wherein
said analyzer automatically parses said message indicating occurrence of said performance deficiency to identify a category of said performance deficiency.

11. A system according to claim 10, wherein
said analyzer automatically identifies said category of said performance deficiency by at least one of, (a) text string matching and (b) key word matching and
said analyzer initiates generation of an alert message to a particular participant associated with said identified category of performance deficiency based on a stored map associating said particular participant with said category.

12. A system according to claim 1, wherein
said analyzer analyzes said data in said records by statistically evaluating error frequency of identified performance deficiencies associated with particular workflow tasks.

13. A system for use in improving management of a workflow process, said workflow process comprising a sequence of tasks to be performed by at least one individual, comprising:
an interface processor for receiving a message indicating occurrence of a performance deficiency in a workflow process;
a data processor for storing a plurality of records in at least one repository, said records comprising data representing workflow context information and information identifying a plurality of corresponding performance deficiencies, in response to said received message; and
an analyzer for initiating generation of an alert message to a user in response to analyzing said records.

14. A user interface system for use in improving management of a workflow process, said workflow process comprising a sequence of tasks to be performed by at least one individual to support healthcare delivery to a patient, comprising:
a display generator for initiating display of data representing at least one image enabling a user to enter data identifying a performance deficiency in a workflow process;
a data processor for storing a plurality of records in at least one repository, said records comprising data representing workflow context information and information identifying a plurality of corresponding performance deficiencies, in response to said entered data identifying said performance deficiency; and
an analyzer for analyzing said data in said record identifying said performance deficiency to support improvement of said workflow process.

15. A system according to claim 14, wherein
said at least one image supports user entry of items including at least one of,
(a) data identifying a particular performance deficiency by selection from a predetermined list of items indicating predetermined categories of performance deficiency,
(b) text concerning a particular performance deficiency,
(c) data selecting a checkbox identifying a particular performance deficiency from a plurality of checkboxes associated with a corresponding plurality of predetermined categories of performance deficiency,
(d) data identifying a particular performance deficiency,
(e) data identifying a magnitude of a particular performance deficiency,
(f) data identifying urgency of a particular performance deficiency and
(g) data identifying user dissatisfaction with particular workflow task performance.

16. A system according to claim 15, wherein
in response to said user entry of said items, said data processor stores said records comprising data representing workflow context information.

17. A system according to claim 14, wherein
said at least one image includes pre-populated items including at least one of, (a) a time, (b) a user identifier, (c) a context identifier, (d) a workflow task identifier, (e) a workflow process input parameter, (f) a workflow process output parameter, (g) a decision rule applied in said workflow process, (h) a location, (i) an active participant, and (j) a workflow task result, and (k) a terminal identifier.

18. A system according to claim 14, wherein
said data processor stores a pointer for use in locating said records in said at least one repository.

19. A system according to claim 14, wherein
said display generator initiates display of data representing a workflow image supporting user performance of a task involved in delivering healthcare to a patient, said workflow image including an image element enabling user initiation of display of said data representing said at least one image enabling a user to enter data identifying said performance deficiency in said workflow process.

20. A system according to claim 14, including
said display generator automatically selects a particular image for display enabling a user to enter data identifying said performance deficiency in said workflow process, said particular image being selected based on a type of workflow task associated with said performance deficiency.

21. A system according to claim 20, wherein
said particular image for display is selected from images including at least one of, (a) an option list, (b) a bar enabling entry of a value on a scale, (c) a bar enabling entry of a coloured element representing a value on a scale, (d) a message initiation option, (e) a hotline initiation option and (f) an urgency selection option.

22. A system according to claim 14, including
a database associating said performance deficiency with a particular type of user interaction, said type of user interaction being associated with at least one of, (a) input of data in support of a workflow process, (b) output of data in response to a workflow process and (c) a decision made in support of a workflow process and
said display generator automatically selects an image for display in response to said particular type of user interaction associated with said type of workflow task.

23. A system according to claim 14, including
a database associating said performance deficiency with a particular attribute, said attribute comprising at least one of, (a) presence of data in a workflow process, (b) lateness of arrival of data in response to a workflow process, (c) quality of performance of a task of a workflow process, (d) resources associated with a workflow process, (e) responsibility for a task of a workflow process, (f) urgency associated with a task of a workflow process and (g) severity of a problem associated with performance of a task of a workflow process, and
said display generator automatically selects an image for display in response to said particular attribute.

24. A system according to claim 14, including
a database associating said performance deficiency with a particular type of user interaction, said type of user interaction being associated with at least one of, (a) input of data in support of a workflow process, (b) output of data in response to a workflow process and (c) a decision made in support of a workflow process.

25. A system according to claim 24, wherein
said database associates a category of performance deficiency with said type of user interaction.

26. A system according to claim 14, including
said at least one image enables a user to interactively modify an image supporting user entry of data identifying a performance deficiency in a workflow process.

27. A system according to claim 14, including
a database associating said performance deficiency with a particular type of user interaction, said type of user interaction being associated with at least one of, (a) input of data in support of a workflow process, (b) output of data in response to a workflow process and (c) a decision made in support of a workflow process.

28. A method for use in improving management of a workflow process, said workflow process comprising a sequence of tasks to be performed by at least one individual, said method comprising the activities of:
receiving a message indicating occurrence of a performance deficiency in a workflow process;
storing records in a repository, said record comprising data representing current workflow context information and information identifying said performance deficiency, in response to said received message; and
analyzing said data in said record identifying said performance deficiency to support improvement of said workflow process.

29. A method for use in improving management of a workflow process, said workflow process comprising a sequence of tasks to be performed by at least one individual, said method comprising the activities of:
receiving a message indicating occurrence of a performance deficiency in a workflow process;
storing a plurality of records in at least one repository, said records comprising data representing workflow context information and information identifying a plurality of corresponding performance deficiencies, in response to said received message; and
initiating generation of an alert message to a user in response to analyzing said records.

30. A method for providing a user interface for use in improving management of a workflow process, said workflow process comprising a sequence of tasks to be performed by at least one individual to support healthcare delivery to a patient, said method comprising the activities of:
initiating display of data representing at least one image enabling a user to enter data identifying a performance deficiency in a workflow process;
storing a plurality of records in at least one repository, said records comprising data representing workflow context information and information identifying a plurality of corresponding performance deficiencies, in response to said entered data identifying said performance deficiency; and
analyzing said data in said record identifying said performance deficiency to support improvement of said workflow process.
